(19) United States
(12) Patent Application Publication
(10) Pub. No.: US 2026/0336725 A1
(43) Pub. Date: Oct. 29, 2026

(54) AN ACTIVE AIR DEFLECTOR FOR A VEHICLE HAVING A MORPHABLE SURFACE

(71) Applicant: Magna Exteriors Inc., Aurora (CA)

(72) Inventors: Daniel VANDER SLUIS, Rochester Hills, MI (US); Parvinder WALIA, Troy, MI (US); Oliver PACE, Clarkston, MI (US); Braendon R. LINDBERG, Metamora, MI (US)

(73) Assignee: Magna Exteriors Inc., Aurora, ON (CA)

(21) Appl. No.: 18/997,420

(22) PCT Filed: Aug. 24, 2023
(86) PCT No.: PCT/US2023/072805

§ 371 Date: Jan. 21, 2025

Related U.S. Application Data
(60) Provisional application No. 63/400,533, filed on Aug. 24, 2022.
(60) Provisional application No. 63/434,218, filed on Dec. 21, 2022.
(60) Provisional application No. 63/444,687, filed on Feb. 10, 2023.
(60) Provisional application No. 63/445,392, filed on Feb. 14, 2023.

(51) Int. Cl. B62D 35/00; B62D 37/02

(52) U.S. Cl. CPC B62D 35/00; B62D 37/02

(57) ABSTRACT

A morphable surface for enhancing vehicle aerodynamics. A vehicle includes a vehicle part having an outer layer of polymer material and an opening formed through the vehicle part. The vehicle part is any part on the exterior or interior of the vehicle. One example includes a vehicle fascia or hood. Covering the opening is a flap portion on the vehicle part that has an outer layer and a plurality of struts connected to an inside surface of the outer layer. The flap portion is selectively moveable between an open and closed position. There is also an elongated connection connected to the least two of the plurality of struts for moving the flap portion between an open position, where air can flow through the vehicle part and a closed position where the flap portion covers and prevents air from flowing through the aperture.

### FIELD OF THE INVENTION

The present invention relates to a morphable surfaces on a motor vehicle using a combination of materials to enable flexibility and shape changing capability, as part of the existing exterior solution (fascia, fender, spoiler, etc.).

### BACKGROUND OF THE INVENTION

Airflow past a vehicle can affect many aspects of vehicle performance including vehicle drag, vehicle lift and down force, and cooling/heat exchange for a vehicle powertrain and air conditioning systems. Reduction in vehicle drag improves fuel economy and also improves vehicle lift and downforce which affects vehicle stability and handling. As used herein, the term “airflow” refers to the motion of air around and through parts of a vehicle relative to either the exterior surface of the vehicle or surfaces of elements of the vehicle, along which exterior airflow can be directed, such as surfaces in the engine compartment.

Devices used to control airflow on the vehicle are generally of a predetermined, non-adjustable geometry, location, orientation and stiffness. Such devices generally do not adapt as driving conditions change, thus the airflow relative to the vehicle cannot be adjusted to better suit the changing driving conditions. Additionally, current under-vehicle airflow control devices can reduce ground clearance. Vehicle designers are faced with the challenge of controlling the airflow while maintaining sufficient ground clearance to avoid contact with and damage by parking ramps, parking blocks, potholes, curbs and the like. Further, inclement weather, such as deep snow slush or rainfall, can damage the device and/or impair vehicle handling.

Current stationary airflow control devices may be adjustable by mounting and/or connecting the devices to hydraulic, mechanical, electrical actuators and/or the like. For example, some vehicle spoilers may adjust location and/or orientation in response to an actuator signal. However, such actuators generally require additional components such as pistons, motors, solenoids and/or like mechanisms for activation, which increase the complexity of the device often resulting in increased failure modes, maintenance, and manufacturing costs. Therefore, there exists a need for an adjustable device for controlling vehicle airflow under varying driving conditions that enhances device simplicity while reducing device problems and the number of failure modes.

Vehicles often employ many different types of sensors and cameras that assist in providing real world data that is used for many active and passive vehicle functions. For example, ultrasonic sensors are used to provide notice of objects and their relationship to the vehicle. Cameras are used for determining when automatic wipers are to be operated or to provide data for automated driving systems. Temperature sensors are used to provide ambient temperature data to the operator of the vehicle. More recently sensors are being utilized heavily with advanced driver-assist, semi-autonomous or fully autonomous systems, which rely on the input of various sensors (Optical, Ultrasonic, Radar, LiDAR, IR, etc.) to capture environmental and traffic data. Clear sensor vision under all vehicle operating conditions has to be ensured to guarantee safe and uninterrupted operation. Different sensor types require different boundary conditions regarding applicability and performance (e.g., camera and LiDAR need unobstructed optical view while a radio frequency radar might be covered by certain materials, which may affect its performance and range). It is absolutely critical to have measures taken to ensure robust and reliable sensor performance for safety. Soiling during adverse weather conditions is hazardous for autonomous driving because droplets and particles can cause obstructions and degradation of sensor signals. It also reduces the ability of autonomous vehicles to navigate safely. It is desirable to develop ways of cleaning and preventing soiling of the sensors so they can operate in all types of conditions.

### SUMMARY OF THE INVENTION

The development of morphing technology for use in vehicles has been focused on developing different solutions that provide a balance of desired aerodynamic benefits and aesthetics with efficiency. Efficiency in this particular area involves developing solutions that require low power to operate, thereby conserving the energy draw from the vehicle as well as providing solutions that are low weight and have a smaller packing space thereby further conserving the available energy from the vehicle.

The present invention is directed to morphable surface for enhancing vehicle aerodynamics. A vehicle includes a vehicle part having an outer layer of polymer material and an opening formed through the vehicle part. The vehicle part is any part on the exterior or interior of the vehicle. One example includes a vehicle fascia or hood. Covering the opening is a flap portion on the vehicle part that has an outer layer and a plurality of struts connected to an inside surface of the outer layer. The flap portion is selectively moveable between an open and closed position. There is also an elongated connection connected to the least two of the plurality of struts for moving the flap portion between an open position, where air can flow through the vehicle part and a closed position where the flap portion covers and prevents air from flowing through the aperture.

Another aspect of the present invention is directed to a morphable surface for enhancing vehicle aerodynamics having a vehicle part with an outer layer of polymer material and an opening formed through the vehicle part. The opening allows for air flow through the vehicle part. A flap portion of the outer layer of the vehicle part is selectively moveable between an open position, where air can flow through the vehicle part, and a closed position, where the flap portion of the outer surface covers and prevents air from flowing through the aperture. The flap portion has been e-beam treated to create a cross-link polymer material in the flap portion and provide stiffness to the flap portion.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic diagram of the process for electron beam treatment of the flap portion of the vehicle part.

FIG. 2 is a schematic diagram of the flap portion.

FIG. 3A is a schematic diagram of a multi-layered flap construction.

FIG. 3B is an alternative multi-layered flap construction.

FIG. 4A is a side perspective view of a flexi-rod.

FIG. 4B is a side elevational schematic view of a morphable surface having of a flap portion, cross-struts and the flexi-rod actuator.

FIG. 5 is a side elevational schematic view of a morphable surface having a flap portion with cross-struts and a belt actuator.

FIG. 6A is a front perspective view of a flap portion according to an alternate embodiment of the invention.

FIG. 6B is a front perspective view of a flap portion according to another alternate embodiment of the invention.

FIG. 7 is a side perspective view of the flap portion shown moving between two positions according to the alternate embodiment of the invention.

FIG. 8A is a schematic view of a morphable surface having a flexi-rod actuator with a flap portion in the closed position.

FIG. 8B is a schematic view of the morphable surface of FIG. 8A having a flexi-rod actuator with the flap portion in the open position.

FIG. 8C is a schematic view of an alternative embodiment of a morphable surface having two flexi-rod actuators in the closed position.

FIG. 8D is a schematic view of an alternative embodiment of a morphable surface having two flexi-rod actuators in the open position.

FIG. 9A is a front perspective view of a morphable surface arrangement in the open position according to one embodiment of the invention.

FIG. 9B is a side elevational view of the morphable surface arrangement of FIG. 9A.

FIG. 9C is a front perspective view of a morphable surface arrangement in the open position according to an alternate embodiment of the invention.

FIG. 9D is a side elevational view of the morphable surface arrangement of FIG. 9C.

FIG. 9E is a front perspective view of a morphable surface arrangement in the open position according to an alternate embodiment of the invention.

FIG. 9F is a side elevational view of the morphable surface arrangement of FIG. 9E.

FIG. 10A is a front side perspective view of a morphable surface arrangement with a flap portion in the closed position.

FIG. 10B is a front side perspective view of a morphable surface arrangement with a flap portion in the open position.

FIG. 10C is a front side perspective view of an exploded morphable surface arrangement with a flap portion removed from a frame.

FIG. 11A is a cross sectional side perspective view of a flap portion in the closed position and actuated by a four bar link according to another embodiment of the invention.

FIG. 11B is a cross sectional side perspective view of a flap portion in the open position and actuated by a four bar link according to another embodiment of the invention.

FIG. 12A is a rear side perspective view of a flap portion in the closed position and actuated by a four bar link according to the present embodiment of the invention.

FIG. 12B is a rear side perspective view of a flap portion in the open position and actuated by a four bar link according to the present embodiment of the invention.

FIG. 13 is a rear perspective view of a flap portion with a limited end boundary plate according to another embodiment of the invention.

FIG. 14A is a rear perspective view of a vehicle part having a plurality of flaps actuated by a single actuator according to another embodiment of the invention.

FIG. 14B is a side perspective view of a vehicle part having a plurality of flaps as shown in FIG. 14A.

FIG. 15 shows a schematic diagram showing the elements of a morphable surface having enhanced aerodynamics as discussed below and shown in FIGS. 3A, 3B 4A,

FIG. 16 is a side schematic view of an active air deflector for soiling mitigation of a sensor on a vehicle.

### DETAILED DESCRIPTION OF THE PREFERRED EMBODIMENTS

The following description of the preferred embodiments is merely exemplary in nature and is in no way intended to limit the invention, its application, or uses.

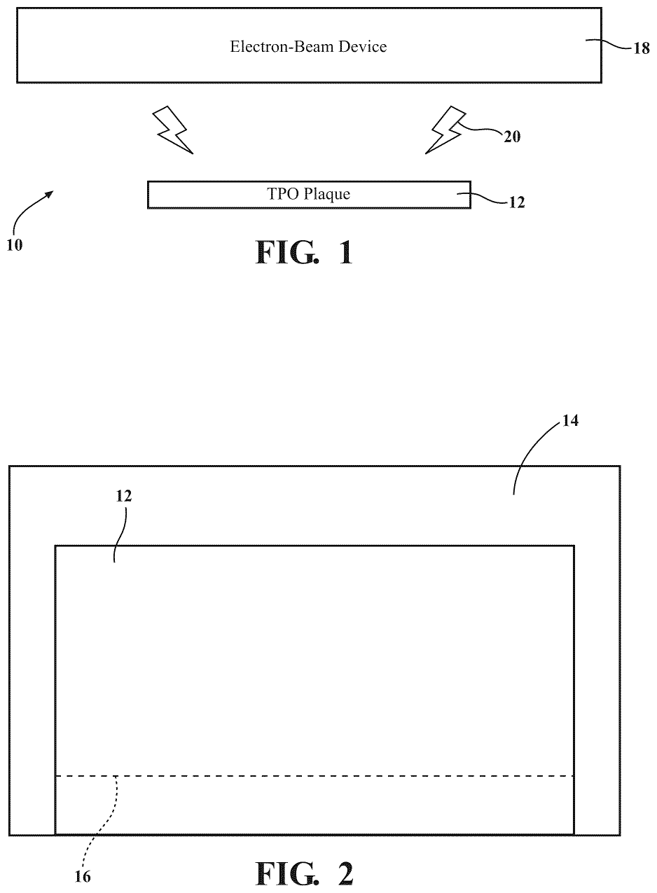

Referring now to FIGS. 1 and 2 a morphable surface for enhancing vehicle aerodynamics and a method of cross-linking 10 a flap portion 12 of the vehicle part 14 is shown. The vehicle part 14 has an outer layer of polymer material and an opening formed through the vehicle part. The opening allows for air flow through the vehicle part 14. The flap portion 12 is a portion of the outer layer of the vehicle part 14 that is selectively moveable between an open position, where air can flow through the vehicle part, and a closed position, where the flap portion 12 of the outer surface covers and prevents air from flowing through the aperture. The morphable surface is a flap portion 12 formed on a vehicle part 14, where the flap portion 12 is not a separate piece but is a portion of the vehicle part 12 that has been cut around the opening of the vehicle part. The flap portion 12 includes a living hinge 16 that is integral with the vehicle part and allows the flap portion 12 to move between the open and closed positions. The flap portion 12 also has suitable stiffness to effectively open and close the opening.

In order to provide the flap portion 12 with suitable stiffness, the material of the flap portion 12 of the vehicle part is treated so it is cross-linked. As shown in FIG. 1 the flap portion is e-beam treated by an e-beam device 18 to create a cross-link polymer material in the flap portion 12 and provide stiffness to the flap portion 12. The flap portion 12 can be any type of cross-linkable material; however, one specific material is thermoplastic olefin (TPO), which when irradiated by an electron beam 20 forms a cross-link at a desired location to stiffen the material. The enhanced stiffness makes the flap portion 12 more rigid, which combined with the living hinge 16 allow the flap portion 12 to move between the open position, closed position and any intermediate position between the open position and the closed position.

To make plastic suitable for being a morphable surface, one of the key qualities is thinness of the material, which allows for the bending and moving of the morphable surface. One suitable thermoplastic material is Hytrel® which is a thermoplastic elastomer manufactured by Celanese Corporation, 222 W. Las Colinas Blvd., Suite 900N Irving, Texas 75039. With injection molding the minimum possible thickness has been limited to materials that are greater than 2.5 mm. However, in contrast the morphable surface according to the various embodiments of the present invention is a material produced without injection molding techniques and having a thickness that is less than or equal to 2.5 mm. This invention is not limited to how the material is made and it is within the scope of this invention for material to be a layered laminate or treated material, using e-beam treatment described herein.

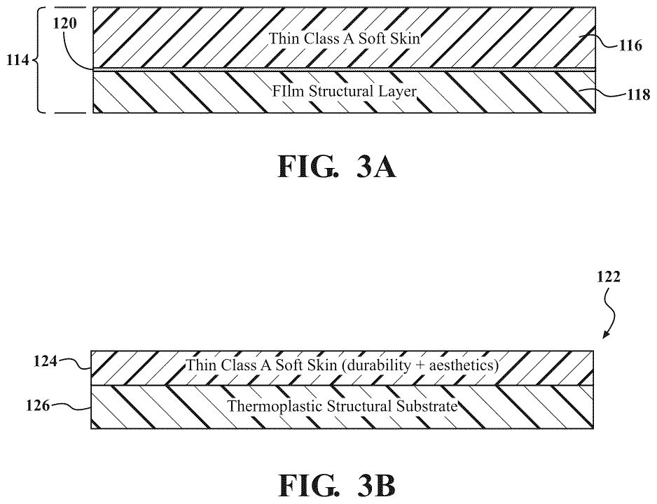

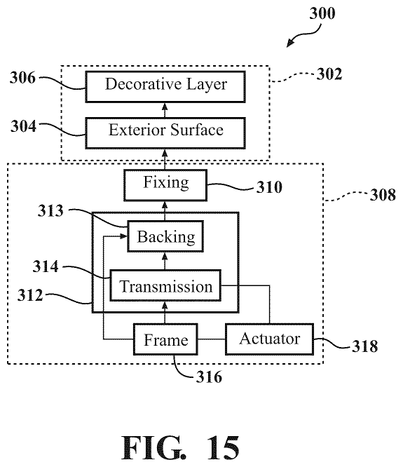

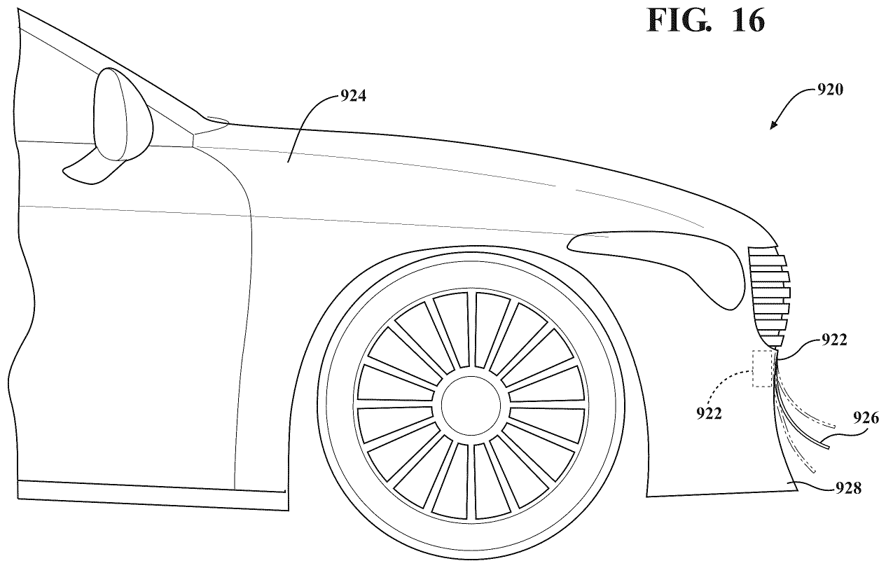

FIG. 15 is a schematic diagram showing the elements of a morphable surface having enhanced aerodynamics as discussed below and shown in FIGS. 3A, 3B 4A, 4B, 5, 8A, 8B, 8C and 8D. The morphable surface 300 includes a decoration 302 that includes an exterior surface 304 with a decorative layer 306 applied to the exterior surface. The decorative layer 306 can have what is known in the automotive field as a Class A surface or it can be some type of surface look, such as a carbon fiber, powder coating or other desirable appearance. The decoration 302 is entirely flexible or has a flexible region that allows the decoration 302 to move or bend between an open position and a closed position. Behind the decoration 302 is a nonvisible control system 308 that includes a fixing 310 which is a static portion that connects a portion of the back side of the decoration 302. The nonvisible control system 308 also includes a dynamic portion 312 that has a backing 313 that connects to a portion of the decoration 302 that moves between the open and closed position. The non-visible control system 308 further includes a transmission 314 which is a flexi-rod style transmission, rack and pinion or belt as described in the embodiments above. The transmission 314 has a portion operably connected to the backing 313, and another portion connected to an actuator 318 that is mounted to a frame 316 portion of the non-visible control system 308.

Referring now to FIG. 3A as shown there is a schematic diagram of one possible layered construction of a morphable surface that is part of a cross-linked flap portion 112 that has been e-beam treated at desired locations according to FIGS. 1 and 2. In the present embodiment of the invention the flap portion 112 is formed of a multi-layered laminate 114. The multi-layered laminate 114 includes an exterior layer 116 formed of elastomeric material. There is also an interior layer 118 of elastomeric material having a durometer rating higher than the exterior layer 116. Between the exterior layer 116 and the interior layer 118 is an adhesive layer 120 the holds the exterior layer 116 and the interior layer 118 together. While an adhesive layer 120 is shown, it is an optional layer that can be excluded in some applications. One possible method of cross-linking the material contemplates using an electron beam to treat the surface. The cross-linking of the material improves the impact strength, durability, creep resistance and heat resistance. Different possibly material types include thermoplastic materials, including specific examples such as polyethylene, TPO and Nylon. The thickness of the material is between 0.75 mm to 2.0 mm.

Referring now to FIG. 3B an alternative material construction for a morphable surface material 122 is shown, which is a multiple layer morphable surface comprised of a first layer 124 (e.g., durability skin layer) and a second layer 126 (e.g., structural layer). The first layer 124 is a thin Class A soft skin layer that is a thermoset material, such as polyurethane or acrylic. The first layer 124 has a max thickness of preferably, less than or equal to 0.5 mm greater, and can also be one selected from a group including 0.1 mm, 0.2 mm, 0.25 mm, 0.3 mm, 0.4 mm and 0.49 mm. The second layer 126 under the outer layer is a thermoplastic structural substrate that is a thermoplastic material such as polycarbonate, thermoplastic olefin, Polyethylene or acrylonitrile butadiene styrene. The second layer 126 has a maximum thickness of less than or equal to 1.5 mm, and can also be one selected from the group including 1 mm, 1.10 mm, 1.2 mm, 1.25 mm, 1.30 mm, 1.40 mm. The total construction of the second alternative material is a total of not more than 2.0 mm, with a minimum of 0.75 mm.

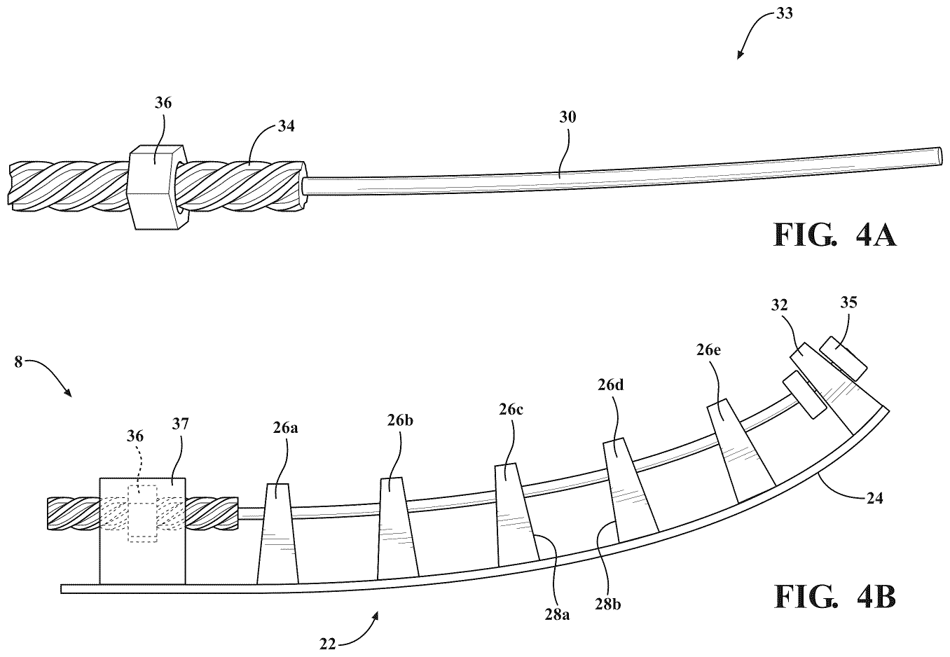

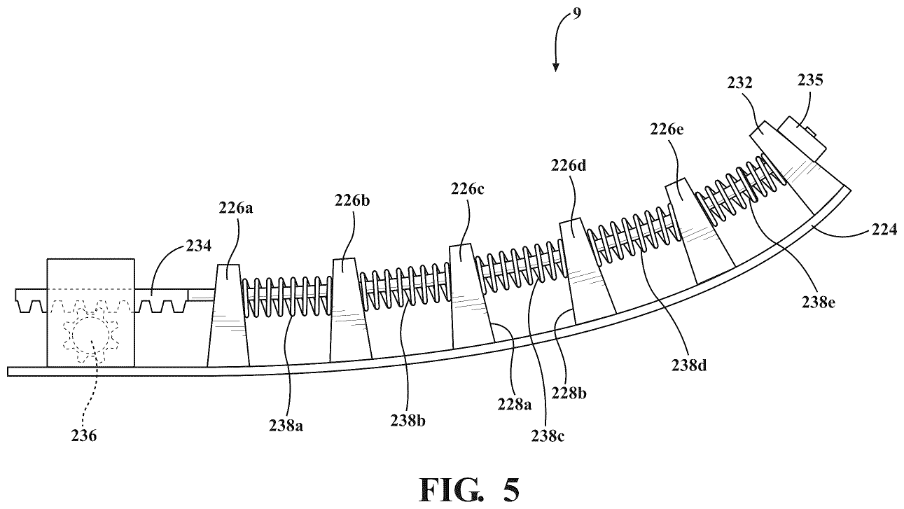

Referring now to FIGS. 4A, 4B and 5 a morphable surface 8, 9 according to a couple of embodiments are shown. More specifically FIGS. 4B and 5 show a flap portion 22, 222 of a vehicle part having an outer layer 24, 224 of polymer material and an opening formed through the vehicle part. The outer layer 24, 224 is a thin layer of less than 2 mm, but ideally around 1 mm in thickness. The outer layer 24, 224 has a class A exterior finish and is formed of a polymeric material. In the present embodiment of the invention the outer layer is formed from thermoplastic olefin (TPO). Connected to the inside surface of the outer layer 24, 224 are a plurality of struts 26a-e, 226a-e that extend across the flap portion 22, 222 and provide stiffness and rotation points as the flap portion 22, 222 moves between the closed position and the open position. The struts 26a-e, 226a-e are intermediate struts that are positioned between a distal strut 32, 232 and an actuator input 36, 236, which can be a motor, gear, nut or any suitable connection with a source of power, such as a motor, for moving the flap portion 22, 222. In an alternative embodiment of the invention the distal strut 32, 232 can include an integrated elastic interconnected features that provide return force to move the flap portion 22, 222 back to the closed position. It is possible for this alternative embodiment to be used in order to eliminate the springs 238-a-e shown in FIG. 5 and described below.

While eight struts are shown It is within the scope of this invention for there to be a greater or lesser number of struts depending on the need of a particular application. Also, the spacing between each of the struts can be greater or lesser depending on the need of a particular application. Greater spacing between struts will allow more bending or curving of the outer layer 24, 224 between the struts. The struts 26a-e, 226a-e are formed of a polymer material that can adhere to the outer layer 24, 224 through a molding process. The struts 26a-e, 226a-e are not connected and are separated from each other so that an angled surface 28a, 28b, 228a, 228b of the struts 26a-e, 226a-e can contact an adjacent angled surface of the adjacent strut when the flap portion 22, 222 is moved to the open position. In FIGS. 4B and 5 angled surface 28a, 28b, 228a, 228b has been respectively labelled between struts 26c, 26d, 226c, 226d, however these angled surfaces are present between all of the struts 26a-e, 226a-e.

Between each strut portion 26a-e, 226a-e is an elongated connection 30, 230 for moving the flap portion 22, 222 between an open position, where air can flow through the vehicle part and a closed position, where the flap portion 22, 222 covers and prevents air from flowing through the aperture. The elongated connection 30, 230 can be connected to just two of the struts 26a-e, 226a-e or as shown the elongated connection 30, 230 is connected to all of the struts 26a-e, 226a-e which allows for finer control and finite positioning of the flap portion 22, 222 at an intermediate position between the fully open position and the fully closed position. The elongated connection 30, 230 is connected to each of the struts 26a-e, 226a-e in a way that it slidably passes through each of the struts 26a-e, 226a-e. As shown in FIGS. 4 and 5 the elongated connection 30, 230 is connected to the distal strut 32, 232 at the end of the flap portion 22, 222 so that the elongated connection 30, 230 pulls the flap portion 22, 222 from the distal strut to curl flap portion 22, 222 to the open position. Also, in embodiments where the elongated connection 30, 230 has sufficient stiffness, the elongated connection 30, 230 can be used to push the flap portion 22, 222 to the closed position.

As shown in FIGS. 4A and 4B the movement of the flap portion 22 is provided by a flexible transmission 33, which is also referred to as a flexi-rod. The flexible transmission 33 is a multi-piece component that includes the elongated connection 30. The elongated connection can be a solid rod, flexible rod that has suitable stiffness for pushing and pulling the flap 22, but still can bend or curve. Other possible elongated connections 30 include a chain or a locking belt. The elongated connection 30 shown in FIG. 4B connects or passes through all of the struts 26a-e and is connected to the distal strut 32 using a stopper 35. The stopper can be a fastener and washer, an over molded stop or any other suitable connection that prevents the end of the elongated connection 30 from pulling through the distal strut 32. The flexible transmission 33 further includes a threaded portion 34 that is driven by the actuator input 36 which causes the elongated connection 30 to slide left (as shown in FIG. 4B) to pull on the struts 26a-e and move the flap to the open position. When the actuator input 36 rotates in the other direction the elongated connection 30 will slide to the right and cause the flap portion 22 to move to the closed position as the elongated connection 30 pushes the distal strut 32 and the struts 26a-e, moving the flap portion 22 to the closed position. The stiffness of the flap portion 22 also biases the flap portion to move toward the close position. The elongated connection 30 is somewhat flexible but is stiff enough to provide a tensile load during opening and a compressive load during closing of the flap portion 22. In one embodiment of the invention the elongated connection 30 is a flexible metal wire or semi-stiff polymer, however it is within the scope of the invention for any suitable material to be used. The threaded portion 34 is a helical gear that is driven by a connection with a motor. While a helical gear is described it is withing the scope of this invention for the threaded portion 34 to be one of a spur gear, double helical gear, herringbone gear, bevel gear, worm gear or hypoid gear depending on the particular application. The threaded portion is moved 34 by rotation of the actuator input 36, which is shown as a nut that is rotated by a motor 37. Referring now to FIG. 5 an alternate embodiment shows the elongated connection 230 as a belt slidably connected through the struts 226a-e. The belt has an actuator input 236 that includes a rack portion 234 of a rack and pinion transmission. The rack portion 234 engages an actuator input 236 which is a gear driven by a motor 237. While a rack and pinion transmission is shown is within the scope of this invention to connect the belt to a helical gear or some other mechanism.

The end of the elongated connection 230 is connected at the distal strut 232 using a stopper 235, which can be a fastener or over molded connection. When the actuator input 236 is actuated in a first direction, the elongated connection 230 (i.e., the belt) will move to the left (as show in FIG. 5) and pull the distal strut 232 and stopper 235 thereby causing the flap portion 222 to move to the open position. When the actuator input 236 is rotated in an opposing second direction elongated connection 230 (i.e., the belt) will move to the right (as shown in FIG. 5) and the stiffness of the flap portion 222 causes it to move back to the closed position. Alternatively, as shown there are a number of springs 238a-e located between each strut 226a-e and between strut 226e and distal strut 232, that are biased to push the flap portion 222 to the closed position when the belt portion moves to the right. It is also within the scope of this invention for the springs to be used in the connection with the elongated connection 30 (i.e., the flexi-rod) shown in FIG. 4. In another alternate embodiment the elongated connection 230a-e is a chain that has locking segments so that when the actuator input 236 moves the flap 222 to the open position the segments are not locked and the chain will pull and bend with the flap 222. As the actuator input 236 is moved in the opposite direction the segments of the chain will stiffen and lock so that the chain is able to apply force or push the flap 222 toward the closed position.

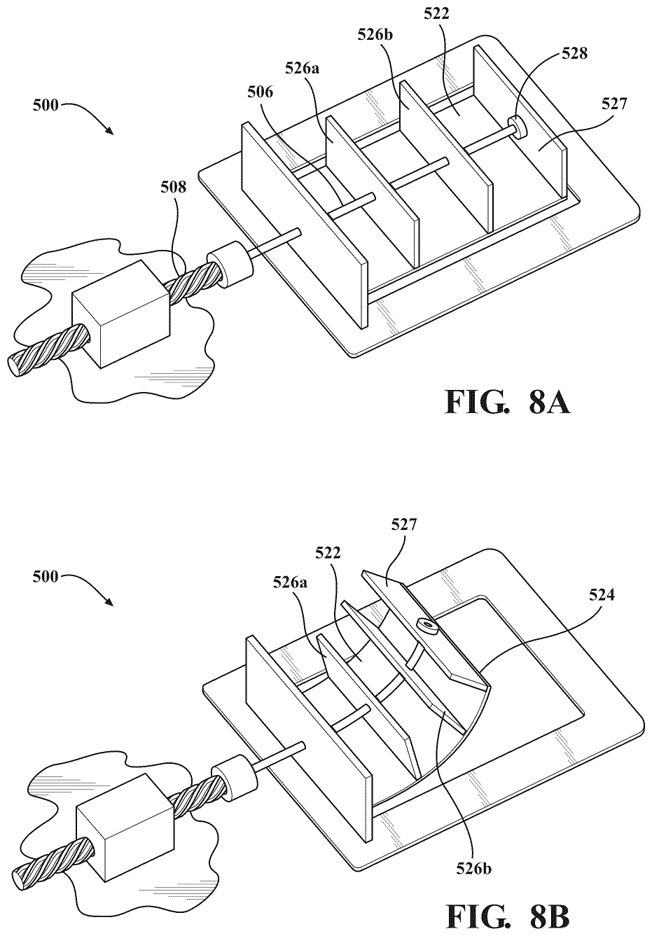

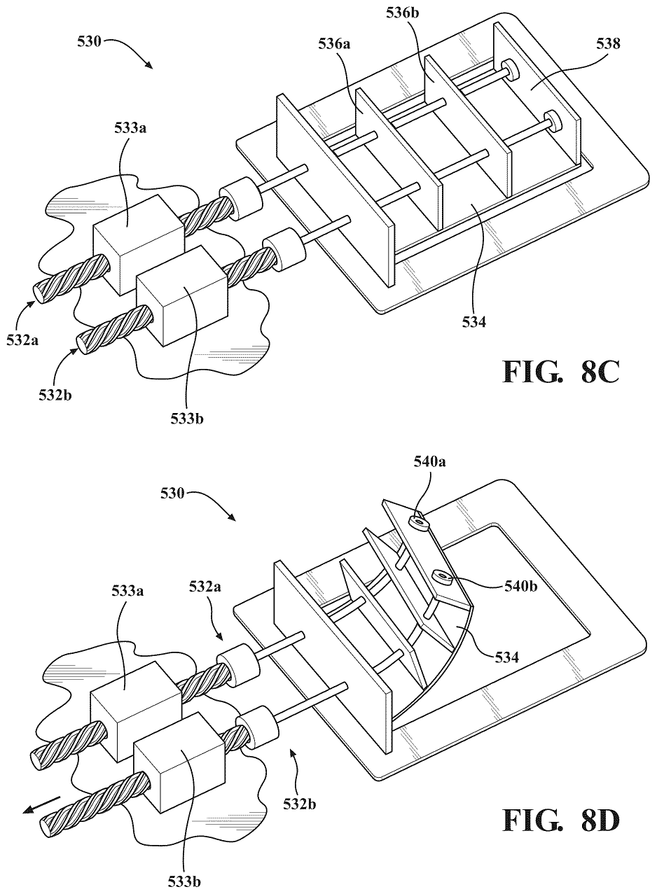

Referring now to FIGS. 8a and 8b a morphable surface 500 having a moveable a flap portion 522 is shown. The flap portion 522 includes struts 526a, 526b and a distal strut 527. The struts 526a, 526b and the distal strut 527 that terminates at an edge 524 of the flap portion 522. There is a flexible connection 504 having an elongated connection 506 that extends through the struts 526a, 526b and connects to the distal strut 527 using a stopper 528. The flexible connection 504 has a threaded portion 508 that connects to an actuator 510 that drives a nut or other suitable connection (not shown) similar to what is shown in FIGS. 4A and 4B. The elongated connection 506 is a rod or wire. This embodiment differs from FIG. 4A in that there are two struts 526a, 526b that are taller and spaced further apart, which allows the flap portion 522 to bend more between the struts 526a, 526b when moved to the open position show in FIG. 8B and the actuator 510 causes the elongated connection 506 to move toward the actuator 510 as shown in FIG. 8B. When the actuator 510 rotates the threaded portion 508 in the other direction the elongated connection 506 moves away from the actuator 510 and the flap portion 522 moves to the closed position as shown in FIG. 8A. The elongated connection 506 is made of material that is stiff enough to push the distal strut 527 and the edge 524 of the flap portion 522 to the closed position.

FIGS. 8C and 8D show a morphable surface 530 that differs from the morphable surface 500 because there are two flexible connections 532a, 532b and two actuators 533a, 533b that connect and move a flap portion 534 between a closed position shown in FIG. 8C and an open position shown in FIG. 8D. In this embodiment the flexible connections 532a, 532b are each slidably connected through struts 536a, 536b and a distal strut 538 at stops 540a, 540b. Operation of the morphable surface 530 is the same as the what is shown in FIGS. 8A, 8B in that the actuators 533a, 533b move the respective flexible connections 532a, 532b between the open and closed position in the same manner (i.e., pushing and pulling the flexible connections toward and away from the respective actuators). However, one difference is that in this embodiment the actuators 533a, 533b are independently actuated which can change how the flap portion 534 moves when opening. One actuator 533a or actuator 533b can be used to move the respective flexible connection 532a, 532b further than the other, thereby causing the flap portion 534 to twist when moved to the open position. For example, in FIG. 8D the actuator 533b has pulled the flexible connection 532b further toward the actuator 532b than the actuator 532a has pulled the flexible connection 532a, thereby causing the flap portion 534 to twist when moved to the open position. This can provide aesthetic advantages or actual design advantages because airflow moving past the flap portion 534 can be altered.

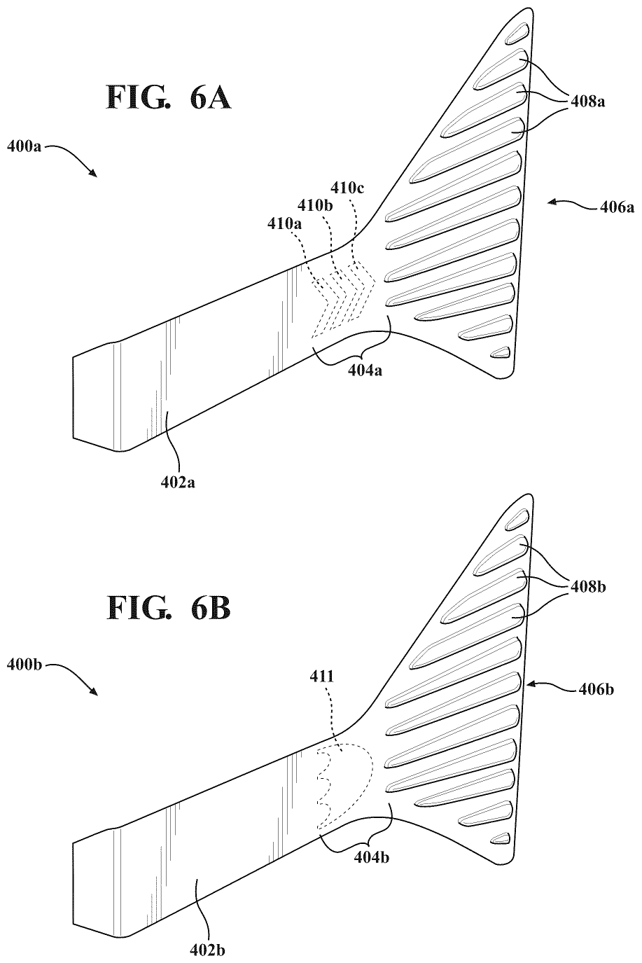

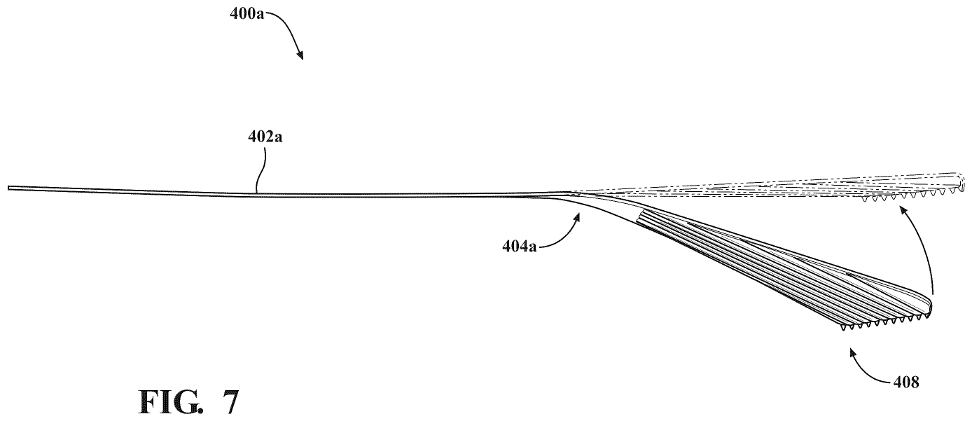

Referring now to FIGS. 6A, 6B and 7 additional aspects of the invention are shown. FIGS. 6A, 6B and 7 show a flap portion 400a, 400b having a frame portion 402a, 402b integrally connected to a multi-axis hinge section 404a, 404b, that connects to a door 406a, 406b. The flap portion 400a, 400b has a multitude of applications, including forming active aerodynamic surfaces, doors for enclosures, HVAC systems, lids, etc. The door 406a, 406b optionally has ribs 408a, 408b formed thereon. The ribs 408a, 408b can be used to provide stiffness, aesthetic appearances and aerodynamic benefits; all depending on the specific application that the flap portion 400a, 400b is implemented with.

The door 406a, 406b is moveable about the multi-axis hinge section 404a, 404b between a first position, second position or any plurality of intermediate positions between the first position and the second position. The multi-axis hinge section 404a of FIGS. 6A and 7 differ from the multi-axis hinge section 404b in that there are different shaped hinge axes that form a muti axis hinge. The hinge sections can have different shapes including a multi-axis hinge that is linear or arcuate in shape depending on a particular application. FIG. 6a, and 7 show a multi-axis hinge 410a, 410b, 410c that are three spaced apart chevron shapes that cause the door 406a to open so that there is a variable axis points that cause the door 406a to move between the open and closed positions so that the door 406a pivots about one of the variable axis points and then moves to a second one of the variable axis points. The variable axis points can be arcuate in shape. As shown in FIGS. 6A and 7 each multi-axis hinge 410a, 410b, 410c has a variable axis point so that the door 606a moves from one multi-axis hinge 410a, 410b, 410c or variable axis point to the next adjacent multi-axis hinge 410a, 410b, 410c or variable axis point as the door 406a moves. This can allow the door to rotate in the X, Y and Z directions when moving from the open to the closed positions. The door 406b in FIG. 6B has a hinge axis 411 that has an umbrella shape that causes different speed of movement of the door 406b as the hinge axis moves across the umbrella shaped hinge axis 411.

Movement of the door 406a, 406b can be accomplished using any of the above describe actuator methods. It is also contemplated that the movement of the door 406a, 406b or any of the flap portions described above can be accomplished using active filaments, which include twisted coil polymers. The actuator would be connected to between the frame portion 402a, 402b and the door 406a, 406b. Alternatively, the actuator can be connected between the frame portion 402a, 402b and the hinge section 404a, 404b.

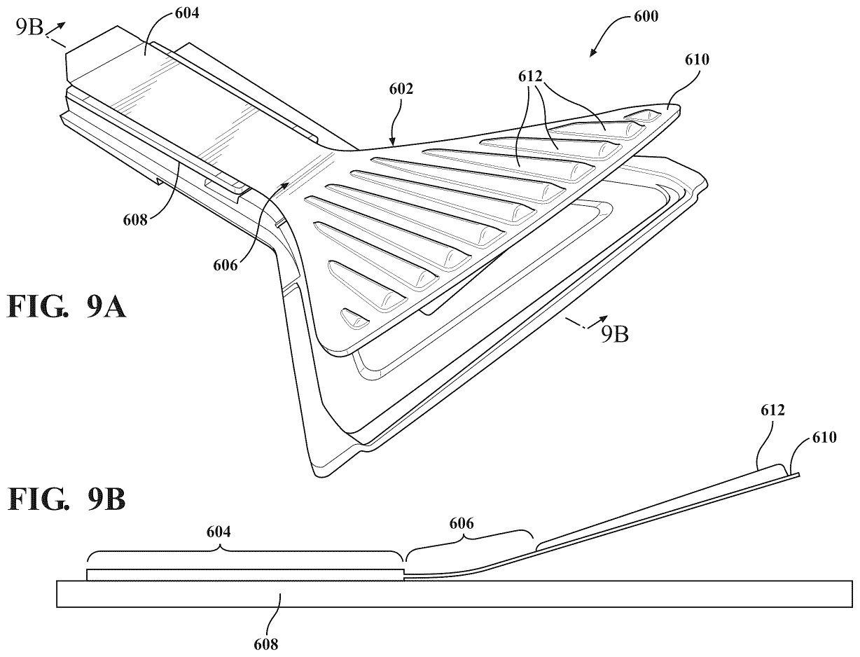

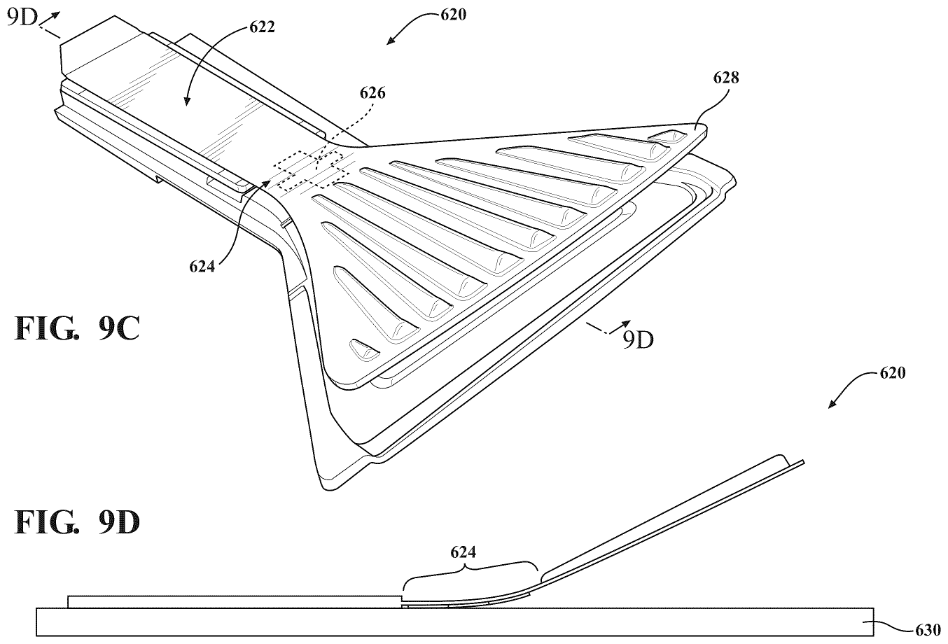

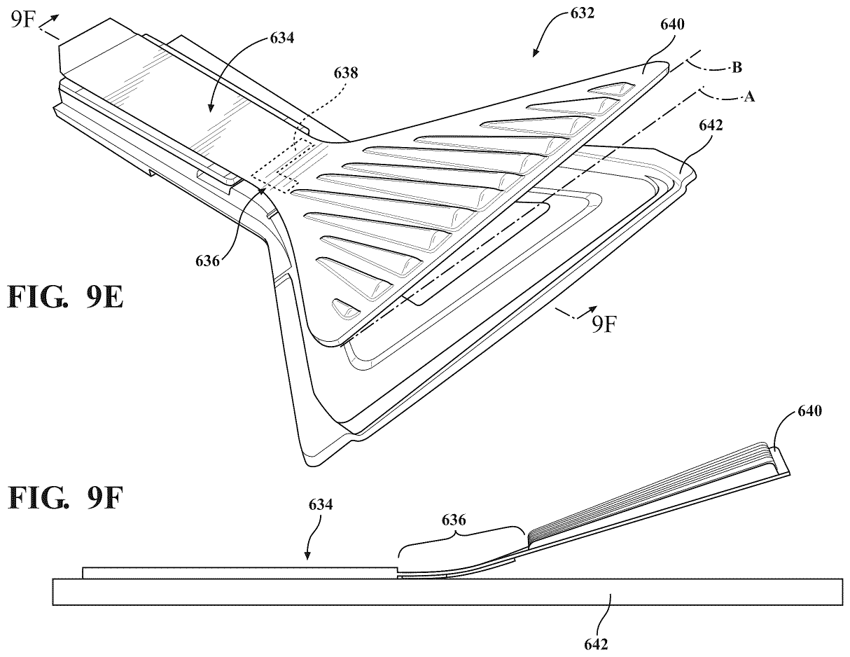

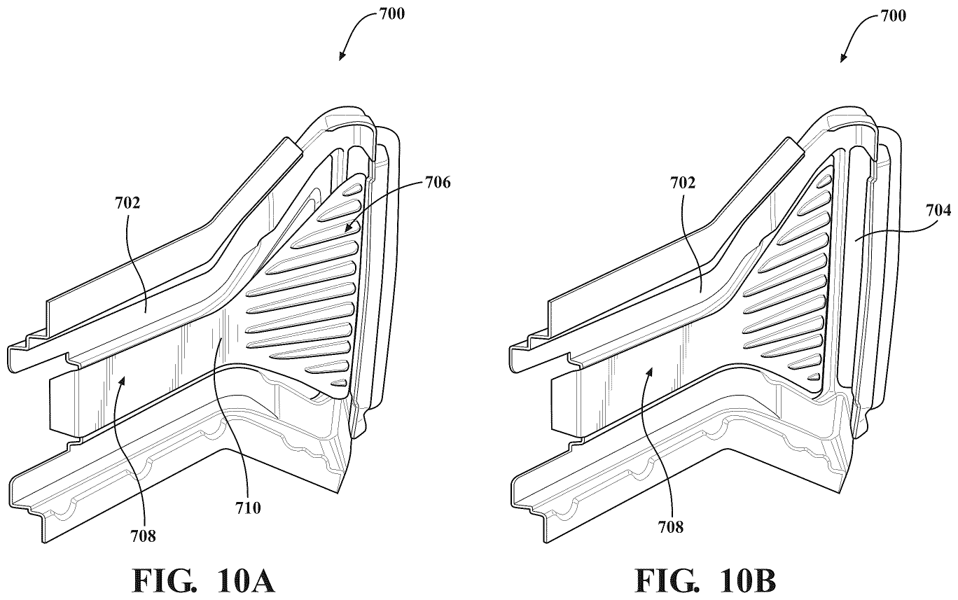

One of the concerns with using morphable surfaces on vehicle exteriors is that the outside surface is often painted and the paint can crack in the flex region of the morphable surface. Referring now to FIGS. 9A and 9B there is shown a morphable surface arrangement 600 which includes a flap portion 602 having a flexible layer of material, which can be polycarbonate or some other suitable material. Using this type of material helps to prevent cracking of paint along the outside surface, especially in a flex region 606 of the flap portion 602. Connected to the back side of a static portion 604 of the flap portion 602 is a frame 608 which provides stiffness to a static portion 604. A moving end 610 of the flap portion 600 has ribs 612 formed thereon for stiffening the moving end 610. As discussed above, the it is sometimes desirable to have the moving end of the flap portion twist or curve as it moves between the closed position and the open position. FIGS. 9C-9F are variations of the morphable surface arrangement 600 shown in FIGS. 9A and 9B, with the main differences being added control layers in the flex region that cause variation in the opening for the moving end of the flap portion. The control layers are layers of material that are semi-rigid and have a desired shape so a moving end of the flap portion will move differently and pivot about different desired axes compared to the movement of the moving end 610 shown in FIGS. 9A and 9B, which have no control layer present in the flex region 606.

Referring now to FIGS. 9C and 9D show a morphable surface arrangement 620 with a flap portion 622 having a flex region 624 with a control layer 626 that has been applied to the backside of the flex region 624 of the flap portion 622. The control layer 626 has a plus sign shape or a cross shape that causes a moving end 628 of the flap portion 622 to bend a greater distance away from a frame 630 when compared to the movement of the moving end 610 of the flap portion 602 relative to the frame 608 shown in FIGS. 9A and 9B. The addition of the control layer 626 also provides stability to help prevent paint cracking in the flex region 624.

Referring now to FIGS. 9E and 9F show a morphable surface arrangement 632 with a flap portion 634 having a flex region 636 with a control layer 638 that has been applied to the backside of the flex region 636 of the flap portion 634. The control layer 638 has a L sign shape that causes a moving end 640 of the flap portion 634 to twist relative to a frame 642 when pivoting between the open and closed positions when compared to the movement of the moving end 610 of the flap portion 602 relative to the frame 608 shown in FIGS. 9A and 9B. The amount of twisting is shown by dashed plane line A, which is the location of the edge of moving end 610 shown in FIGS. 9A and 9B, compared to dashed line B which is the location of the edge of moving end 640. The addition of the control layer 638 also provides stability to help prevent paint cracking in the flex region 636.

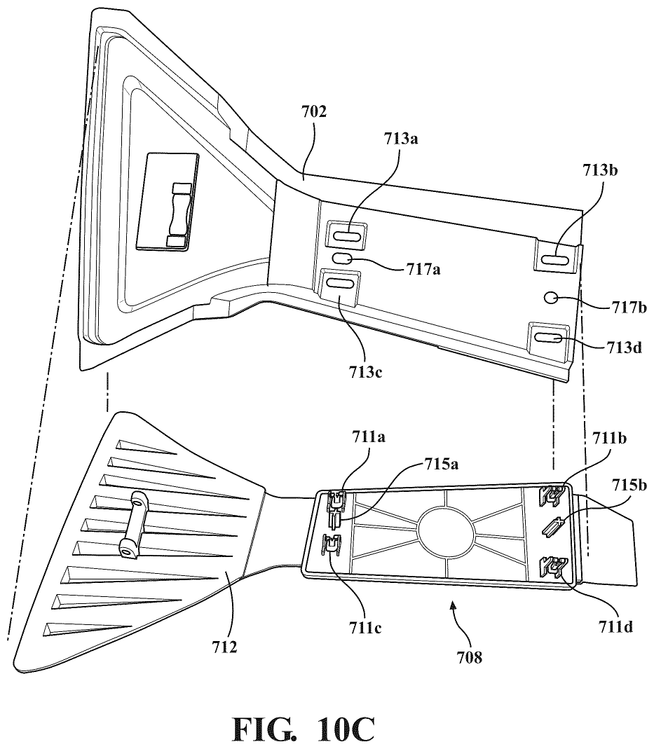

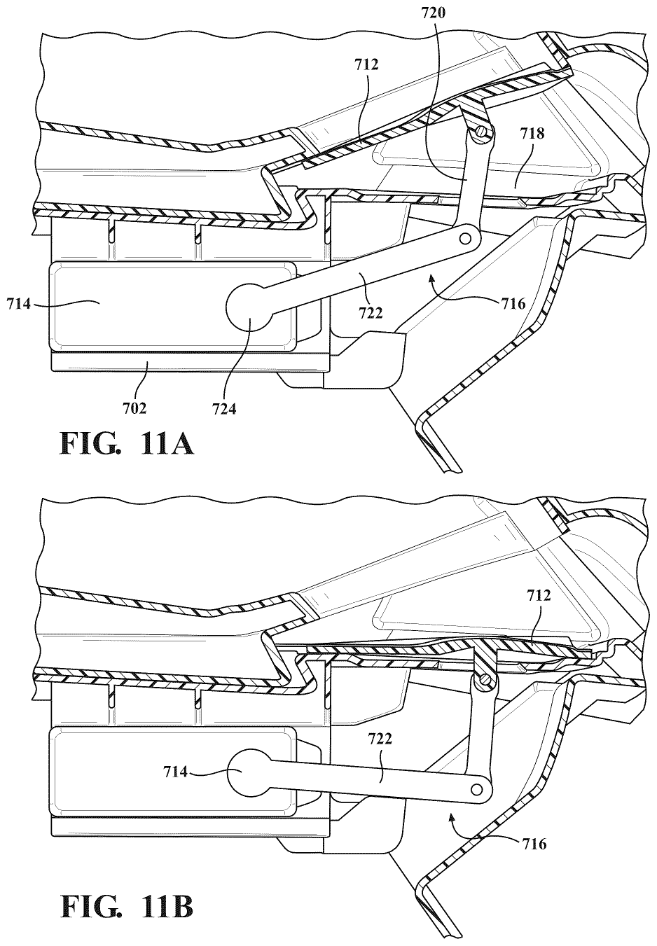

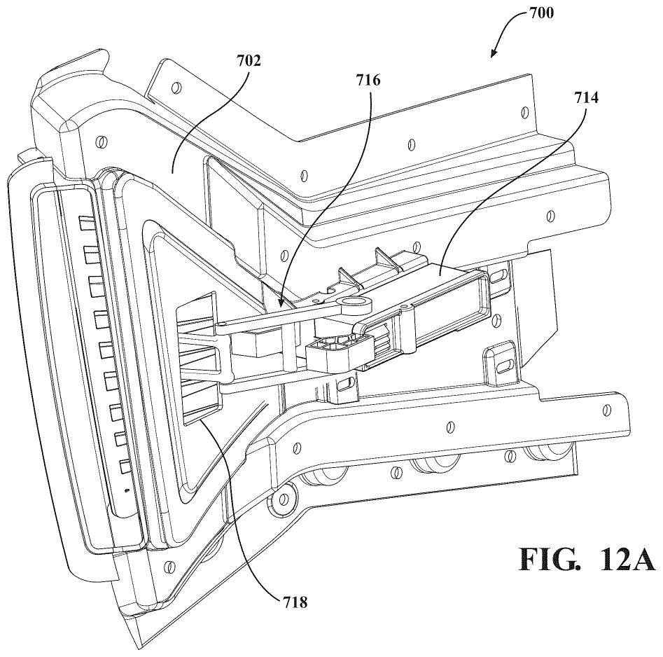

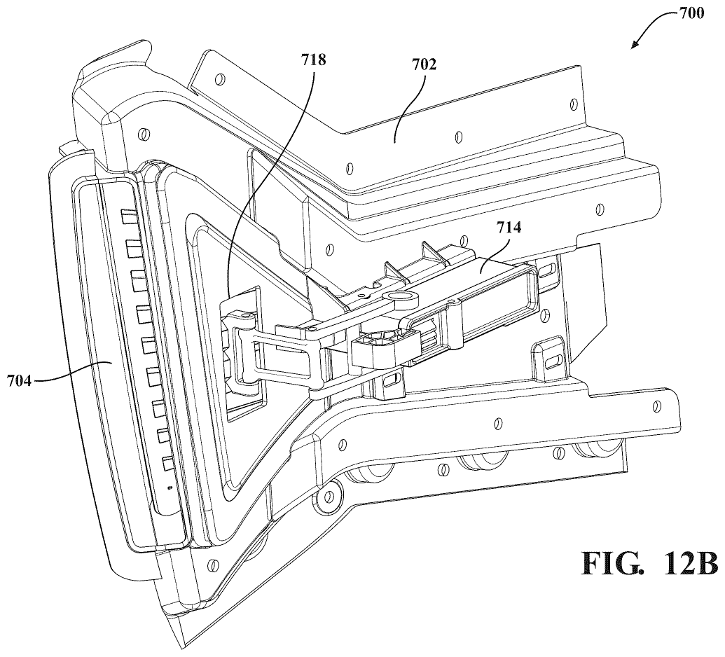

FIGS. 10-12 show a partial view of a morphable surface arrangement 700 with a frame 702 defining an opening 704 that is selectively opened and closed by a moving end 706 of a flap portion 708. The flap portion 708 has a flex region 710 that the moveable end 706 pivots about. The moveable end 706 includes a regional end boundary or backing plate 712 that is connected to the back side of the flap portion 708. An actuator 714 is connected to the frame 702 and has a link 716 that extends through an actuator opening 718 and connects to the backing plate 712. The link 716 is a four bar link where the backing plate 712 is the follower that is pivotally connected to a coupler 720 at a first end. A second end of the coupler 720 is pivotally connected to a first end of a driver 722. A second end of the drive 722 is a connector 724 of the actuator 714 which serves as a ground for the link 716. The actuator 714 moves the link 716 to push and pull the moveable end 706 between the open position, where the opening 704 of the frame 702 is unobstructed, and a closed position where the opening 704 is blocked by the moveable end 706. The moveable end 706 can also be positioned at any intermediate position between the closed and open positions.

FIG. 10C shows an additional aspect of the invention, which involves the serviceability of the flap portion 708. Since the flap portion 708 is exposed to the surrounding elements of the vehicle and moves between the open and closed positions, it can become damaged or worn and will need to be replaced. The flap portion 708 as shown has four snap clips 711a-d that are configured to connect respectively with four apertures 713a-d formed in the frame 702. In order to align the clips 711a-d and apertures 713a-d there are two locator posts 715a, 715b that are configured to align respectively with one of two locator holes 717a, 717b formed in the frame 702. There can be a greater or lesser number of snap clips and locator posts depending on the needs of a particular application. The snap clips 711a-d and apertures 713a-d allow for ease of replacement and serviceability of the flap portion 708.

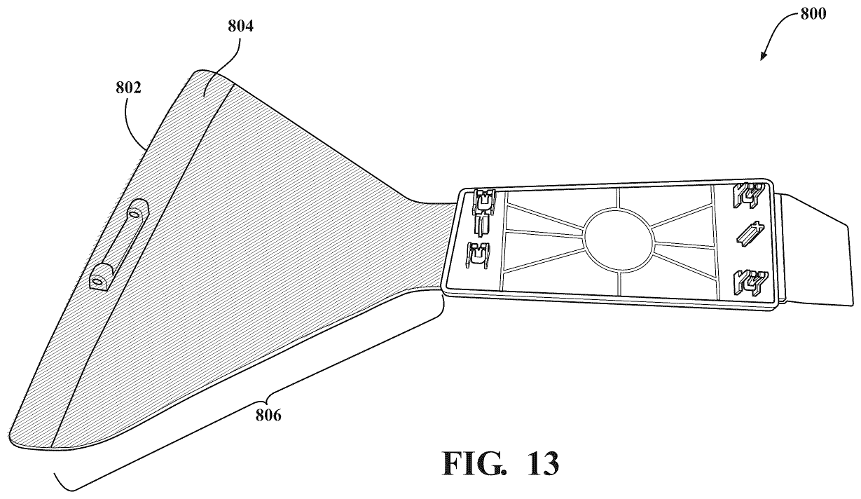

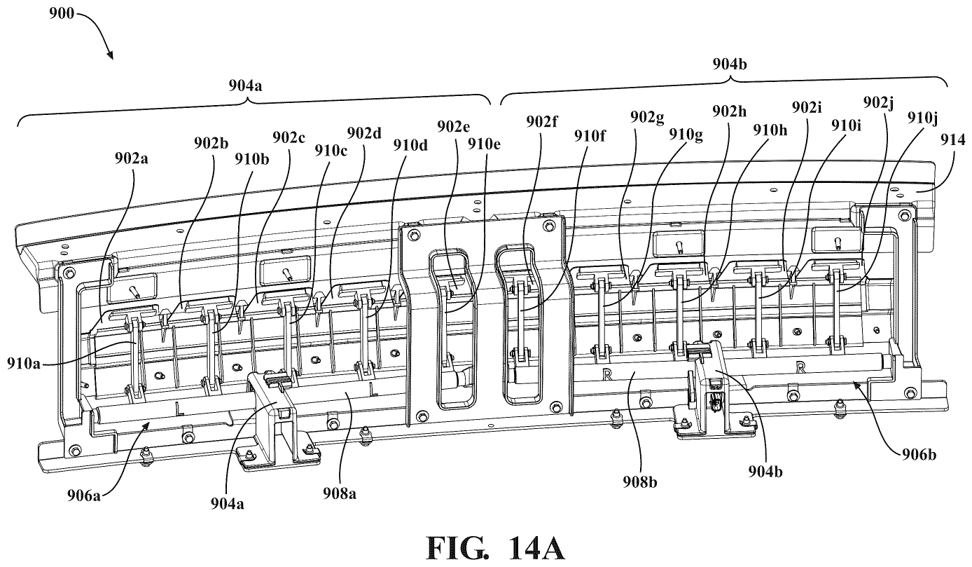

In several of the embodiments described above the flap portion has a backing plate of some sort on one side of the flap portion. Often the backing plate is shown as covering a large region or portion of the flap portion to provide support to the material of the flap portion. FIG. 13 shows a flap portion 800 with a moveable edge 802 and a smaller plate 804 connected to the flap portion 800 adjacent to the moveable edge 802. This smaller plate 804 is also referred to as a limited end boundary plate which provides a larger flex region 806 that is larger than the smaller plate 804, thereby allowing for a much larger region of flex. This further reduces the amount of material and weight of the flap portion 800.

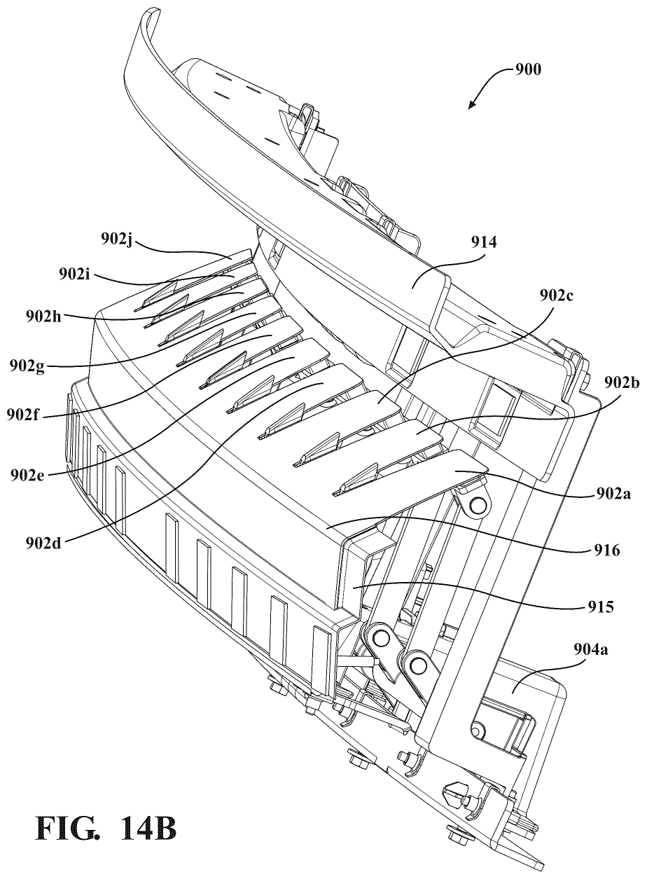

The flap portions in all of the above embodiments can be implemented in applications where a plurality of flap portions are controlled by a single actuator. Referring now to FIGS. 14A and 14B a rear perspective view and a side front perspective view of a vehicle part 900 having a plurality of flap portions forming a morphable surface arrangement. The vehicle part 900 includes a frame 914 with a first bank 901a which includes flap portions 902a-e and a second bank 901b which includes flap portions 902f-j. The first bank 901a of flap portions 902a-e are moveable by an actuator 904a and link 906a and the second bank 901b of flap portions 902b are moveable by an actuator 904b and link 906b. Each link 906a, 906b includes a driver 908a, 908b which is a rod or tube that connects to individual couplers 910a-j and are connected to individual respective flap portions a-j. The driver 908a of the first bank 901a and the driver 908b of the second bank 901b are each rotated bi-directionally by the respective first actuator 904a and the second actuator 904b to push and pull the flap portions 902a-j of the respective first bank 901a and the second bank 901b between the closed position, open position and any intermediate position between the closed position and the open position. The couplers 910a-j are link arms or bars that push and pull on the flap portions 902a-j. The flap portions 902a-j are mounted to a base 915 region of the frame 914 which forms a pivot edge 916 where the flap portions 902a-j rotate about. It is also possible to provide a flex region with a variable axis of movement as described in the embodiments described above. As shown each actuator 904a, 904b is respectively connected to and bidirectionally rotates the driver 908a, 908b. The rotation of the driver 908a, 908b causes the flap portions 902a, 902b of each bank to move between the open and closed positions. Each actuator 904a, 904b can be operated individually, which allows for first bank 901a, and second bank 901b to be opened and closed independently or positioned at an intermediate position independently of each other.

FIG. 16 is a side schematic view of an active air deflector that is part of a soiling mitigation arrangement 920 for of a sensor 922 on a vehicle 924. The active air deflector employs a morphable surface according to any one of the embodiment described above. The soiling mitigation arrangement includes the sensor 922, which is not limited to a single sensor, but it is also within the scope of this invention to include multiple sensors. Also, the position of the sensor 922 at the front grille area of the vehicle 924 is just one example location, it is within the scope of the invention for the sensor to be anywhere else on the vehicle exterior at a location where the sensor is subject to environmental factors such as wind, rain, snow, dirt, etc. The type of sensor is not limited, however, in the present example the sensor is used for autonomous driving or for providing driver warnings and can be a camera, Lidar sensor, ultrasonic sensor or other suitable sensors.

The soiling mitigation arrangement 920 further includes a morphable surface 926 formed on an outside surface 928 of the vehicle 924. The morphable surface 926 is positioned adjacent to or in operable relation to a sensing surface 930 of the sensor 922 such that the morphable surface 926 moves between a stowed position, a plurality of intermediate positions each creating one of a plurality of intermediate airflow paths and a fully deployed position creating a fully deployed airflow path. The plurality of intermediate air flow paths and the fully deployed airflow path each direct airflow across the sensing surface 930 at a different angle, which mitigates soiling of the sensing surface 930.

As mentioned above, the morphable surface 926 has the structure of any of the morphable surfaces described in the embodiments above. In one embodiment the morphable surface 926 has an outer layer that connects kinematically to a support structure to enable movement at a plurality of hinge axes. The morphable surface 926 can also have a living hinge formed therein and the cross-link polymer material is located at the living hinge. Also, the morphable surface 926 can include a multi-layered laminate having an exterior layer formed of elastomeric material, an interior layer of elastomeric material having a durometer rating higher than the exterior layer and an adhesive layer between the exterior layer and the interior layer.

In another aspect of the invention the morphable surface 926 includes an outer layer and a plurality of struts connected to an inside surface of the outer layer. There is further provided an elongated connection connected to the least two of the plurality of struts for moving the flap portion between the stowed position, the plurality of intermediate positions and the fully deployed position. It is also possible for the elongated connection to be a belt connected to the at least two struts and an actuator that causes the elongated connection to move the morphable surface. In another variation the elongated connection is a push rod that is connected to the at least two struts and an actuator that causes the push rod to move between a first position where the push rod pushes the morphable surface to the closed position and a second position where the push rod moves the morphable surface to the open position.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A morphable surface for enhancing vehicle aerodynamics comprising:
a vehicle part having an outer layer of polymer material and an opening formed through the vehicle part;
a flap portion on the vehicle part having an outer layer and a plurality of struts connected to an inside surface of the outer layer, and
an elongated connection connected to the least two of the plurality of struts for moving the flap portion between an open position where air can flow through the vehicle part and a closed position where the flap portion covers and prevents air from flowing through the aperture.

2. The morphable surface for enhancing vehicle aerodynamics of claim 1, wherein the flap portion has a flex region forming a living hinge and the cross-link polymer material is located at the flex region.

3. The morphable surface for enhancing vehicle aerodynamics of claim 1, wherein the flap portion a door and a flexible section with multi-axis hinges that provide variable axis points that cause the door to move between the open and closed positions so that the door pivots about a first one of the variable axis points and then moves to a second one of variable axis points.

4. The morphable surface for enhancing vehicle aerodynamics of claim 1, further comprising:
wherein the flap portion has a flex region formed therein that forms living hinge for movement of the flap portion;
a control layer formed in the flex region that provides stability to the flex region.

5. The morphable surface for enhancing vehicle aerodynamics of claim 4, further comprising:
a flexible layer disposed over entire outer layer of the flap portion, and wherein the control layer is a layer of material that is semi-rigid and has a shape that causes the flex region to pivot about a desired axis as the flap portion moves between the open position and the closed position.

6. The morphable surface of claim 4, wherein the shape of the control layer is an L shape, which causes the flex region to twist when pivoting between the open position and the closed position.

7. The morphable surface for enhancing vehicle aerodynamics of claim 1, wherein the flap potion includes an outer layer of thin Class A soft skin that covers a thermoplastic structural substrate, wherein the combination of the outer layer of thin Class A soft skin and the thermoplastic structural substrate has a thickness less than or equal to 2.5 mm.

8. The morphable surface of claim 1, wherein the elongated connection is part of a flexible transmission that includes a threaded portion that is driven by an actuator input and the elongated connection is a flexible rod connected to the threaded portion, wherein rotation of the actuator input in a first direction moves the threaded and elongated connection in a first direction to pull the flap portion to an open position and rotation of the actuator input in a second direction moves the threaded portion and the elongated connection in a second direction in a second direction to push the flap portion to a closed position.

9. The morphable surface of claim 8, further comprising:
wherein one of the plurality of struts is a distal strut located on the flap portion, and a stopper connecting the flexible rod to the distal strut.

10. The morphable surface of claim 1, wherein the elongated connection includes a belt slidably connected through the plurality of struts and the belt is connected to a rack portion that engages an actuator input which is a gear driven by a motor, wherein rotation of the gear in a first direction pulls the belt and the flap portion to an open position and rotation of the gear in a second direction moves the belt and the flap portion to a closed position.

11. The morphable surface of claim 10, further comprising:
wherein one of the plurality of struts is a distal strut located on the flap portion, and
a stopper connecting the belt to the distal strut.

12. The morphable surface of claim 11, further comprising a spring located between each of the plurality of struts for biasing the flap portion toward the closed position.

13. The morphable surface for enhancing vehicle aerodynamics of claim 1, wherein the flap portion is a multi-layered laminate having an exterior layer formed of elastomeric material, an interior layer of elastomeric material having a durometer rating higher than the exterior layer and an adhesive layer between the exterior layer and the interior layer.

14. A morphable surface for enhancing vehicle aerodynamics comprising:
a vehicle part having an outer layer of polymer material and an opening formed through the vehicle part;
a flap portion on the vehicle part having an outer layer and a plurality of struts connected to an inside surface of the outer layer;
a first flexible connection having an elongated connection connected to the least two of the plurality of struts for moving the flap portion between an open position where air can flow through the vehicle part and a closed position where the flap portion covers and prevents air from flowing through the aperture, and
a second flexible connection having an elongated connection connected to the least two of the plurality of struts for moving the flap portion between an open position where air can flow through the vehicle part and a closed position where the flap portion covers and prevents air from flowing through the aperture.

15. The morphable surface for enhancing vehicle aerodynamics of claim 14, further comprising:
a first actuator connected to the first flexible connection and a second actuator connected to the second flexible connection, and
wherein the first actuator and the second actuator are independently actuated so that one of the first actuator and the second actuator each move a respective one of the first flexible connection and the second flexible connection to move further than the other one of the first flexible connection and the second flexible connection to cause the flap portion to twist when moving from the closed position to the open position.

16. The morphable surface for enhancing vehicle aerodynamics of claim 15, wherein the first flexible connection and the second flexible both further include a threaded portion connected to the elongated connection, wherein the threaded portion is driven by an actuator input of the respective one of the first actuator and the second actuator;
wherein the elongated connection is a flexible rod connected to the threaded portion, wherein rotation of the actuator input in a first direction moves the threaded portion and elongated connection in a first direction to pull the flap portion to an open position and rotation of the actuator input in a second direction moves the threaded portion and the elongated connection in a second direction in a second direction to push the flap portion to a closed position.

17. The morphable surface for enhancing vehicle aerodynamics of claim 14, wherein the flap portion has a flex region forming a living hinge and the cross-link polymer material is located at the flex region.

18. The morphable surface for enhancing vehicle aerodynamics of claim 14, further comprising:
wherein the flap portion has a flex region formed therein that forms living hinge for movement of the flap portion, and
a control layer formed in the flex region that provides stability to the flex region.

19. The morphable surface for enhancing vehicle aerodynamics of claim 18, further comprising:
a flexible layer disposed over entire outer layer of the flap portion;
wherein the control layer is a layer of material that is semi-rigid and has a shape that causes the flex region to pivot about a desired axis as the flap portion moves between the open position and the closed position.

20. The morphable surface of claim 18, wherein the shape of the control layer is an L shape, which causes the flex region to twist when pivoting between the open position and the closed position.

21. The morphable surface for enhancing vehicle aerodynamics of claim 14, wherein the flap potion includes an outer layer of thin Class A soft skin that covers a thermoplastic structural substrate, wherein the combination of the outer layer of thin Class A soft skin and the thermoplastic structural substrate has a thickness less than or equal to 2.5 mm.

22. The morphable surface of claim 14, wherein one of the plurality of struts is a distal strut located on the flap portion, and a first stopper connects the elongated connection of the first flexible connection to the flap portion and a second stopper connects the elongated connection of the second flexible connection to the flap portion.

23. The morphable surface for enhancing vehicle aerodynamics of claim 14, wherein the flap portion a door and a flexible section with multi-axis hinges that provide variable axis points that cause the door to move between the open and closed positions so that the door pivots about a first one of the variable axis points and then moves to a second one of variable axis points.

24. A morphable surface for enhancing vehicle aerodynamics comprising:
a vehicle part having an outer layer of polymer material and an opening formed through the vehicle part;
a flap portion of the outer layer that is selectively moveable between an open position where air can flow through the vehicle part and a closed position where the flap portion of the outer surface covers and prevents air from flowing through the aperture, wherein the flap portion has been e-beam treated to create a cross-link polymer material in the flap portion and provide stiffness to the flap portion.

25. The morphable surface for enhancing vehicle aerodynamics of claim 24, wherein the flap portion of the outer layer will connect kinematically to a support structure to enable movement at a plurality of hinge axes.

26. The morphable surface for enhancing vehicle aerodynamics of claim 24, wherein the flap portion has a living hinge formed therein and the cross-link polymer material is located at the living hinge.

27. The morphable surface for enhancing vehicle aerodynamics of claim 24, wherein the flap portion is a multi-layered laminate having an exterior layer formed of elastomeric material, an interior layer of elastomeric material having a durometer rating higher than the exterior layer and an adhesive layer between the exterior layer and the interior layer.

28. The morphable surface for enhancing vehicle aerodynamics of claim 24, wherein the flap portion a door and a flexible section with multi-axis hinges that provide variable axis points that cause the door to move between the open and closed positions so that the door pivots about a first one of the variable axis points and then moves to a second one of variable axis points.

29. A vehicle part having a morphable surface arrangement comprising:
a vehicle part having a frame;
a first bank including a plurality of flap portions connecting to the frame and movable between a closed position and an open position in response to the actuation of a first actuator;
a second bank including a plurality of flap portions connected to the frame and movable between a closed position and an open position in response to the actuation of a second actuator, and
wherein plurality of flap portions of the first bank and the plurality of flap portions of the second bank are independently operated respectively by the first actuator and the second actuator.

30. The vehicle part of claim 29, further comprising:
a driver connected to the first actuator of the first bank and a plurality of couplers individually connected between a respective one of the plurality of flap portions and the driver, so that all of the plurality of flap portions of the first bank are moved by the first actuator, and
a driver connected to the second actuator of the second bank and a plurality of couplers individually connected between a respective one of the plurality of flap portions and the driver, so that all of the plurality of flap portions of the second bank are moved by the second actuator.

31. The vehicle part of claim 20, wherein the driver of the first bank and the driver of the second bank are each a rod that is rotated bi-directionally by the respective first actuator and the second actuator to push and pull the plurality of flap portions of the respective first bank and the second bank.
